(19) United States
(12) Patent Application Publication
(10) Pub. No.: US 2025/0290167 A1
(43) Pub. Date: Sep. 18, 2025

(54) METHOD FOR LOOSENING MATERIALS IN SHAFT FURNACE DURING DIRECT REDUCTION

(71) Applicant: SICHUAN HUIWEI RONGDA TECHNOLOGY CO., LTD, Mianyang City (CN)

(72) Inventors: Wei ZHANG, Mianyang City (CN); Xiaohui LIU, Mianyang City (CN)

(73) Assignee: SICHUAN HUIWEI RONGDA TECHNOLOGY CO., LTD, Mianyang City (CN)

(21) Appl. No.: 18/762,920

(22) Filed: Jul. 3, 2024

(30) Foreign Application Priority Data
Mar. 18, 2024 (CN) 202410309175.4

(51) Int. Cl. C21B 13/02

(52) U.S. Cl. CPC C21B 13/02

(57) ABSTRACT

Provided is a method for loosening materials in a shaft furnace during direct reduction, including: circumferentially arranging a plurality of electromagnets outside a furnace wall at a cooling section of the shaft furnace, a connecting line between an N pole and an S pole of a magnetic field generated by each of the electromagnets being perpendicular to an axial direction of the shaft furnace; electrically connecting each of the electromagnets to a power control system configured to control energization and de-energization of any one of the electromagnets; and energizing all the electromagnets in turn by the power control system during the direct reduction; wherein when one of electromagnets is energized, all the other electromagnets are in a de-energization state; and taking all the electromagnets energized in turn once as an energization cycle, a next energization cycle is conducted after completing one energization cycle until the direct reduction is finished.

### CROSS REFERENCE TO RELATED APPLICATION

This application claims the benefit and priority of Chinese Patent Application No. 202410309175.4 filed with the China National Intellectual Property Administration on Mar. 18, 2024, the disclosure of which is incorporated by reference herein in its entirety as part of the present application.

### TECHNICAL FIELD

The present disclosure relates to the technical field of metal smelting, in particular to a method for loosening materials in a shaft furnace during direct reduction.

### BACKGROUND

When iron ore is subjected to direct reduction in a gas-based shaft furnace, the volume of the iron ore will expand during the direct reduction, causing a blockage in a chamber of the shaft furnace and thereby leading to shutdown. Moreover, when the chamber of the shaft furnace is blocked, the reduced iron is in a relatively static state for most of the time in the cooling section of the shaft furnace, so that it is difficult to undergo quick and sufficient heat exchange, resulting in that the reduced iron flowing out of the discharge port is oxidized due to high temperature.

At present, the method to solve the above problems is to install a rotating mechanical device in the shaft furnace or the discharge port of the shaft furnace, so as to make the materials move mechanically in the shaft furnace, such as those disclosed in utility model patent CN219956041U and CN219951095U. However, such mechanical devices need to work in a high temperature environment, which leads to high manufacturing cost on one hand and high maintenance cost on the other hand.

### SUMMARY

The present disclosure aims to provide a method for loosening materials in a shaft furnace during direct reduction, so as to solve the above problems in the prior art, making the reduced iron in the shaft furnace loose, avoiding the blockage of the reduced iron in the shaft furnace, and ensuring that the reduced iron could flow out of the shaft furnace smoothly.

To achieve the above objects, the present disclosure provides the following solutions:

The present disclosure provides a method for loosening materials in a shaft furnace during direct reduction including:
circumferentially arranging a plurality of electromagnets outside a furnace wall at a cooling section of the shaft furnace, a connecting line between an N pole and an S pole of a magnetic field generated by each of the electromagnets being perpendicular to an axial direction of the shaft furnace;
electrically connecting each of the electromagnets to a power control system, the power control system being configured to control energization and de-energization of any one of the electromagnets; and
energizing all the electromagnets in turn by the power control system during the direct reduction; wherein under the condition that one of the electromagnets is energized, all the other electromagnets are in a de-energization state; and taking all the electromagnets energized in turn once as an energization cycle, a next energization cycle is conducted after completing one energization cycle until the direct reduction is finished.

In some embodiments, all the electromagnets are uniformly arranged, and the distances between each of the electromagnets and the furnace wall are equal.

In some embodiments, during the direct reduction, each of the electromagnets is periodically energized and de-energized.

In some embodiments, the frequency at which each of the electromagnets is periodically energized and de-energized is in a range of 0.01-50 times per minute.

In some embodiments, a number of the electromagnets is six.

Compared with the prior art, some embodiments of the present disclosure have the following technical effects.

The method for loosening materials in a shaft furnace during direct reduction according to the present disclosure allows the materials in different directions in the shaft furnace to move through a periodically changing magnetic field generated by a plurality of the electromagnets, thereby making the materials in the shaft furnace loose constantly, avoiding the blockage of the reduced iron in the shaft furnace, and ensuring that the reduced iron could flow out of the shaft furnace smoothly.

Furthermore, in the method for loosening materials in a shaft furnace during direct reduction according to the present disclosure, only one power control system and a plurality of electromagnets are required, so that the manufacturing cost is low, and thus the equipment investment could be effectively reduced.

Moreover, in the method for loosening materials in a shaft furnace during direct reduction according to the present disclosure, the electromagnets are arranged outside the shaft furnace, avoiding the influence of the high temperature environment in the shaft furnace on the operation of the electromagnets, and thus making the maintenance cost low.

### BRIEF DESCRIPTION OF THE DRAWINGS

To describe the technical solutions in the embodiments of the present disclosure or in the prior art more clearly, the following briefly introduces the figures used in the examples. Apparently, the figures in the following description show merely some embodiments of the present disclosure, and other figures could be obtained by those skilled in the art according to these figures without creative efforts.

FIG. 1 is a top view of a shaft furnace used in a method for loosening materials in a shaft furnace during direct reduction according to an embodiment of the present disclosure; and

FIG. 2 is a side view of a shaft furnace used in a method for loosening materials in a shaft furnace during direct reduction according to an embodiment of the present disclosure;

wherein 1 represents a shaft furnace; 2 represents a cooling section; 3 represents a discharge port; and 4 represent an electromagnet.

### DETAILED DESCRIPTION OF THE EMBODIMENTS

The technical solutions in the embodiments of the present disclosure will be clearly and completely described below in conjunction with figures used in the examples of the present disclosure. Apparently, the described embodiments are merely a part rather than all of the embodiments of the present disclosure. Based on the embodiments of the present disclosure, other embodiments obtained by those skilled in the art without creative efforts shall be deemed falling within the scope of the present disclosure.

The present disclosure aims to provide a method for loosening materials in a shaft furnace during direct reduction so as to solve the problems in the prior art, making the reduced iron in the shaft furnace loose, avoiding the blockage of the reduced iron in the shaft furnace, and ensuring that the reduced iron could flow out of the shaft furnace smoothly.

To make the foregoing objects, features and advantages of the present disclosure more clear and understandable, the present disclosure will be further described in detail below with reference to the figures and embodiments.

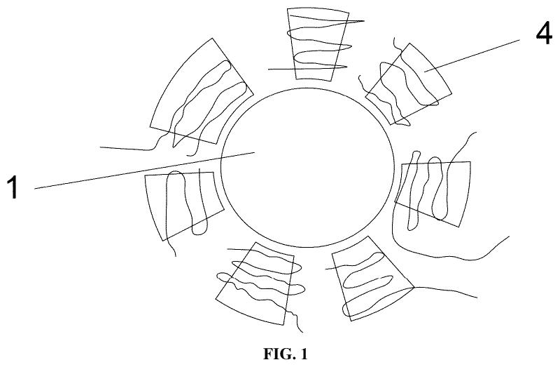

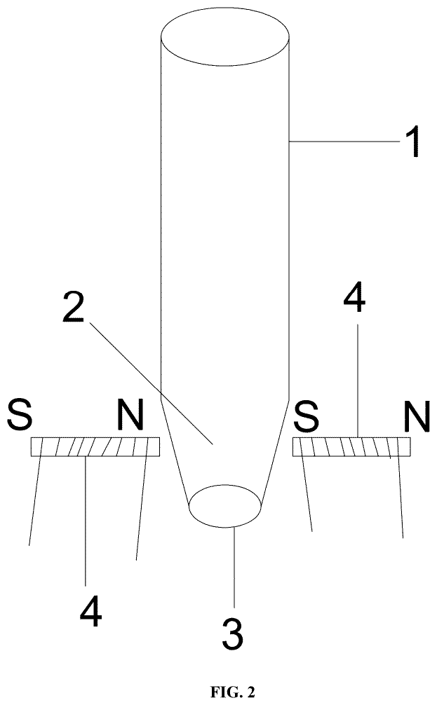

As shown in FIG. 1 to FIG. 2, provided is a method for loosening materials in a shaft furnace during direct reduction, in which:

Six electromagnets 4 is circumferentially arranged outside a furnace wall at a cooling section 2 of the shaft furnace 1, where a connecting line between an N pole and an S pole of a magnetic field generated by each of the electromagnets 4 is perpendicular to the axial direction of the shaft furnace (referring to FIG. 2). Each of electromagnets 4 is electrically connected to a power control system, and the power control system is configured to control energization and de-energization of any one of the electromagnets 4. All the electromagnets 4 are energized in turn by the power control system during the direct reduction; where under the condition that one of the electromagnets 4 is energized, all the other electromagnets 4 are in a de-energization state; and taking all the electromagnets 4 energized in turn once as an energization cycle, a next energization cycle is conducted after completing one energization cycle until the direct reduction is finished.

The principle of the method for loosening materials in a shaft furnace during direct reduction in the embodiment is as follows:

When a certain electromagnet 4 is energized, magnetic lines generated by the electromagnet 4 could penetrate the furnace wall of the shaft furnace 1, so that reduced iron particles in the shaft furnace 1 move towards the electromagnet 4 that generate magnetism. Different electromagnets 4 are arranged in different directions outside the shaft furnace 1, and all electromagnets 4 are energized in turn when working. At the same time only one electromagnet 4 is energized, and the reduced iron particles in the shaft furnace 1 then move towards the energized electromagnet 4. Soon a power of this electromagnet 4 is turned off and another electromagnet 4 in another direction is energized to generate another magnetic field. At this time, the reduced iron particles in the shaft furnace 1 move towards the another direction, so that the reduced iron particles could move continuously in the shaft furnace 1 without caking caused by expansion extrusion. In addition, ores and reduced iron above the cooling section 2 have downward pressure on the reduced iron at the cooling section 2 under the action of gravity, leading to an overall effect that the reduced iron particles in the reduction shaft furnace flow out smoothly to a discharge port 3.

In some embodiments, all electromagnets 4 are uniformly arranged, and the distances between each of the electromagnets 4 and the furnace wall are equal.

In some embodiments, each of the electromagnets 4 is periodically energized and de-energized during direct reduction.

In some embodiments, the frequency at which each of the electromagnets 4 is periodically energized and de-energized is in a range of 0.01-50 times per minute.

What needs illustration is that six electromagnets 4 are arranged in this example, but in practical application, the number of electromagnets 4 could be adjusted adaptively according to actual needs. In order to clearly show the magnetic field direction of the electromagnets 4, only two electromagnets 4 are shown in FIG. 2. The power control system is an existing equipment at present. The power control system is an equipment or a system for controlling power supply, and could realize automatic control, and it could be automatically adjusted through a control circuit to meet the requirements of the equipment. In the example, the power control system is mainly used to control different electromagnets 4 to be energized and de-energized so as to realize automatic energization and de-energization of all electromagnets 4, thereby facilitating use. Those skilled in the art could directly purchase and set the existing power control system to meet the use requirements in the embodiments, and the specific structure and working principle of the power control system are not described in detail in the embodiments.

Specific examples are used for illustration of the principles and implementation of the present disclosure. The description of the above-mentioned embodiments is used to help illustrate the method and concept of the present disclosure. In addition, those skilled in the art can make various modifications in terms of specific embodiments and scope of application according to the concept of the present disclosure. In summary, the contents of this specification should not be understood as the limitation of the present disclosure.

What is claimed is:

1. A method for loosening materials in a shaft furnace during direct reduction, comprising:
circumferentially arranging a plurality of electromagnets outside a furnace wall at a cooling section of the shaft furnace, a connecting line between an N pole and an S pole of a magnetic field generated by each of the electromagnets being perpendicular to an axial direction of the shaft furnace;
electrically connecting each of the electromagnets to a power control system, the power control system being configured to control energization and de-energization of any one of the electromagnets; and
energizing all the electromagnets in turn by the power control system during the direct reduction; wherein under the condition that one of the electromagnets is energized, all the other electromagnets are in a de-energization state; and taking all the electromagnets energized in turn once as an energization cycle, a next energization cycle is conducted after completing one energization cycle until the direct reduction is finished.

2. The method according to claim 1, wherein all the electromagnets are uniformly arranged, and the distances between each of the electromagnets and the furnace wall are equal.

3. The method according to claim 1, wherein during the direct reduction, each of the electromagnets is periodically energized and de-energized.

4. The method according to claim 3, wherein the frequency at which each of the electromagnets is periodically energized and de-energized is in a range of 0.01-50 times per minute.

5. The method according to claim 1, wherein a number of the electromagnets is six.
